(19) United States
(12) Patent Application Publication
(10) Pub. No.: US 2026/0128362 A1
(43) Pub. Date: May 7, 2026

(54) COMPOSITE SOLID ELECTROLYTE, PREPARATION METHOD, AND APPLICATION

(71) Applicant: LiaoNing Petrochemical University, Fushun (CN)

(72) Inventors: Chunyang DUAN, Fushun (CN); Zenghua ZHAO, Fushun (CN)

(73) Assignee: LiaoNing Petrochemical University, Fushun (CN)

(21) Appl. No.: 19/432,134

(22) Filed: Dec. 24, 2025

(30) Foreign Application Priority Data
Jun. 24, 2025 (CN) 202510858352.9

(51) Int. Cl. H01M 10/056; H01M 10/0525

(52) U.S. Cl. CPC H01M 10/056; H01M 10/0525; H01M 2300/0065; H01M 2300/0091

(57) ABSTRACT

This present disclosure relates to the technical field of lithium-ion batteries, and particularly to a composite solid electrolyte, along with its methods of preparation and application. The preparation method comprises the following steps: mixing PEO, lithium bis(trifluoromethanesulfonyl)imide, and acetonitrile, subsequently adding the Prussian blue analogues, followed by stirring and ultrasonicating to obtain a mixed solution; the mixed solution is then formed into the composite solid electrolyte using the electrospinning technique. This present disclosure utilizes the Prussian blue analogues with a three-dimensional nanochannel structure and high specific surface area as a raw material. After preparation of the composite solid electrolyte, the pores of the composite solid electrolyte are larger and uniformly distributed, and the special pore structure establishes more stable and efficient ion transport channels, enabling smoother ion conduction and leading to enhanced electrochemical performance.

### TECHNICAL FIELD

The present disclosure relates to the technical field of lithium-ion batteries, in particular to a composite solid electrolyte, preparation method, and application.

### BACKGROUND

Poly(ethylene oxide) (PEO)-based solid electrolytes have been widely studied due to their unique ability to coordinate lithium ions. However, the low ionic conductivity at room temperature and insufficient mechanical strength caused by the high crystallinity of intrinsic defects seriously restrict their practical applications. In recent years, the introduction of inorganic fillers has been considered as an effective strategy to improve the performance of PEO. However, traditional oxides find it difficult to achieve the synergistic optimization of electrochemical-mechanical properties due to poor interfacial compatibility and blocking the continuous transmission of lithium ions.

### SUMMARY

The purpose of the present disclosure is to provide a method of preparating a composite solid electrolyte, including the following steps.

S1, mixing PEO, lithium bis(trifluoromethylsulfonyl)imide and acetonitrile, then adding Prussian blue analogues, stirring and ultrasonicating to obtain a mixed solution; and S2, using electrospinning to make the mixed solution into a composite solid electrolyte.

In some embodiments, a mass of lithium bis (trifluoromethylsulfonyl)imide in S1 is 0.5 %-1 % of the mass of PEO.

In some embodiments, acetonitrile is only use as a solvent, and dosage is not limit.

In some embodiments, a mix time in the present disclosure is 4-6 h.

In some embodiments, the Prussian blue analogues in S1 includes Fe₄[Fe(CN)₆]₃, CuFe[Fe(CN)₆], and K_{0.95}Ag_{3.05}Fe(CN)₆.

In some embodiments, the mass of Prussian blue analogues in S1 accounts for 0.01 %-10 % of the mass of PEO.

In some embodiments, the mass of Prussian blue analogues in S1 accounts for 0.1 %-0.5 % of the mass of PEO.

In some embodiments, a stirring time in S1 is 1-3 h, an ultrasonic time is 20-40 min, and an ultrasonic frequency is 42-45 Hz.

In some embodiments, the mixed solution is stirred at 60° C. for 12 h before electrospinning to obtain a pretreated mixed solution.

In some embodiments, an electrospinning process includes: placing the pretreated mixed solution in a syringe and connecting it to a high-voltage power supply; using a grounded drum collector while keeping a fixed distance between a needle tip of syringe and the drum fixed; and after obtain a composite membrane, drying the composite membrane it to complete the electrospinning process.

In some embodiments, avoltage of electrospinning in S2 is 22-24 kV, and a flow rate of electrospinning is 0.015-0.025 mL/h.

In some embodiments, a rotation speed of the ground drum collector is 400 r/min, and a distance from the needle tip of syringe to the drum is 16 cm.

The present disclosure also provides a composite solid electrolyte prepared by the preparation method of the composite solid electrolyte.

The present disclosure also provides an application of the composite solid electrolyte in a lithium-ion battery.

The present disclosure has the following beneficial effects

A preparation method of the composite solid electrolyte provid by the present invention comprises the following steps: S1, mixing PEO, lithium bis(trifluoromethylsulfonyl)imide, and acetonitrile, then adding Prussian blue analogues, stirring and ultraultrasonicating to obtain a mixed solution; S2, using electrospinning to form the mixed solution into a composite solid electrolyte. Prussian blue analogues with a three-dimensional nano-pore structure and high specific surface area are being selected as raw materials. The prepared composite solid electrolyte exhibit large pores and uniform distribution. A more stable and efficient ion conduction channel are constructed by the special pore structure, which makes the ion conduction proceed more smoothly.

After adding Prussian blue analogues, a ‘filler-polymer’ interface layer is formed on the surface of the composite solid electrolyte. The interface layer inhibits crack propagation during stretching and improving the tensile strength of the composite solid electrolyte.

The present disclosure also provides the application of the composite solid electrolyte in the lithium-ion battery. The composite solid electrolyte obtained by the preparation method of the invention exhibits low resistance, and ions are moving more efficiently through the channels formed by Prussian blue analogues, this reduces the obstacles in the transmission process, makes ion conduction proceed more easily, and significantly improves ion conductivity.

The technical scheme of the present disclosure is further described in detail through the drawings and Examples.

### BRIEF DESCRIPTION OF THE DRAWINGS

FIG. 1 is a SEM image of the composite solid electrolyte prepared by Example 3 and Comparison case 1 of the present disclosure;

where FIG. 1(a) is a SEM image of Comparison case 1 when the magnification is 1500 times, and FIG. 1(b) shows a SEM image of the Example 1 when the magnification is 1500 times; FIG. 1(c) shows a SEM image of Comparison case 1 when the magnification is 1500 times, and FIG. 1(d) is a SEM image of Example 1 when the magnification is 1500 times;

FIG. 2 is an XRD analysis diagram of the composite solid electrolyte prepared by Comparison cases 1 and 2, and Examples 1-5 of the present disclosure;

FIG. 3 is a stress-strain curve comparison diagram of the composite solid electrolyte prepared by Examples 1-5 of the present disclosure and Comparison case 1 and 2;

FIG. 4 is a thermal performance analysis and comparison diagram of the composite solid electrolyte prepared by Example 3 and Comparison case 2 of the present disclosure;

where FIG. 4(a) is a DSC curve comparison diagram, FIG. 4(b) is a TGA curve comparison diagram, and FIG. 4(c) is the DTG curve comparison diagram;

FIG. 5 is a comparison of the electrochemical performance of the lithium symmetrical battery after the composite solid electrolyte prepared by Example 3 of the present disclosure and Comparison case 2 is assembled into a lithium symmetrical battery;

where FIG. 5(a) shows an impedance comparison at room temperature after the implementation of Example 3 and Comparison case 2 assemble into a lithium symmetric battery; FIG. 5(b) shows an impedance scaling at room temperature after the implementation of Example 3 assembled into a battery; FIG. 5(c) shows an impedance curve at different temperatures after the implementation of Example 3 assembled into a battery and FIG. 5(d) shows a conductivity curve at different temperatures after the implementation of Example 3 assembled into a battery;

FIG. 6 shows a voltage polarization curve of the lithium symmetric battery assembled according to Example 3 of the present disclosure;

where FIG. 6(a) shows a voltage polarization curve over 200 h at a current density of 0.1 C; FIG. 6(b) shows an amplified view of the voltage polarization curve at the beginning of the cycle at a current density of 0.1 C; FIG. 6(c) shows an amplified view of the voltage polarization curve near the 200 h mark at a current density of 0.1 C; and FIG. 6(d) shows a voltage polarization curve under different current densities;

FIG. 7 is a cycle performance test diagram of a lithium iron phosphate/lithium sheet battery assembled by Example 3 of the present disclosure;

where FIG. 7(a) is a charge-discharge cycle curve of lithium iron phosphate/lithium battery at different cycles, and FIG. 7(b) is a cycle performance diagram of lithium iron phosphate/lithium battery at 0-100 cycles;

FIG. 8 is a test diagram of the cycle rate performance of lithium iron phosphate/lithium sheet battery assembled by Example 3 of the present disclosure;

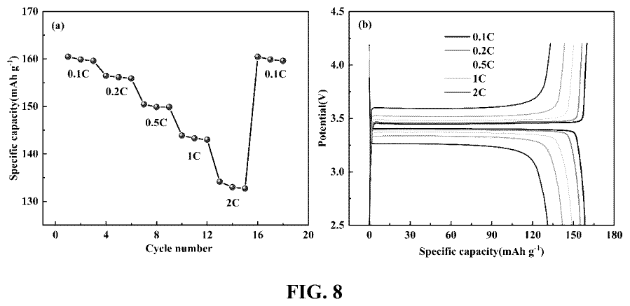

where FIG. 8(a) is a rate performance test diagram of the lithium iron/osphate/ lithium sheet battery at different rates, FIG. 8(b) is a charge and discharge cycle diagram of the lithium iron phosphate/lithium sheet battery at different rates.

### DETAILED DESCRIPTION OF THE EMBODIMENTS

The following is a further description of the present disclosure in combination with drawings and implementation examples. Unless otherwise defines, the technical terms or scientific terms used in the invention should be understood by people with general skills in the field to which the invention belongs. The above-mentioned features mentioned in the invention or the features mentioned in specific examples can be arbitrarily combined. These specific implementation examples are only use to illustrate the invention and are not used to limit the scope of the invention.

### Example 1

The preparation method of the composite solid electrolyte comprises the following steps:

S1: 5 g of PEO, 0.05 g of lithium bis(trifluoromethanesulfonyl)imide, and acetonitrile are stirring for 5 h, and then 0.005 g of Fe₄[Fe(CN)₆]₃ is added. After stirring for 2 h, the mixed solution is obtained by ultrasonication at a frequency of 44 Hz for 30 min.

S2: after stirring the mixed solution at 60° C. for 12 h, the pretreated mixed solution is obtained. The pretreated mixed solution is placed a 10 mL plastic syringe with a stainless steel needle and connects to a high-voltage power supply. The applied voltage is maintained at 23 kV, and the flow rate of the syringe is set to 0.02 mL/h. A ground drum collector (400 r/min) is used to obtain a uniform membrane, and the distance from the tip to the drum is fixed at 16 cm. The composite solid electrolyte is obtained by taking out the spun membrane and drying it in a vacuum oven at 55° C. for 48 h, recorded as PEO/0.1%/PB-fiber.

### Example 2

The preparation method is essentially the same as that of the composite solid electrolyte provided in Example 1, with the difference being that the mass of Fe₄[Fe(CN)₆]₃ is 0.025 g, recorded as PEO/0.5%/PB-fiber.

### Example 3

The preparation method is essentially the same as that of the composite solid electrolyte provided in Example 1, with the difference being that the mass of Fe₄[Fe(CN)₆]₃ is 0.05 g, recorded as PEO/1%/PB-fiber.

### Example 4

The preparation method is essentially the same as that of the composite solid electrolyte provided in Example 1, with the difference being that the mass of Fe₄[Fe(CN)₆]₃ is 0.15 g, recorded as PEO/3%/PB-fiber.

### Example 5

The preparation method is essentially the same as that of the composite solid electrolyte provided in Example 1, with the difference being that the mass of Fe₄[Fe(CN)₆]₃ is 0.25 g, recorded as PEO/5%/PB-fiber.

### Example 6

S1: 5 g of PEO, 0.05 g of lithium bis(trifluoromethanesulfonyl)imide, and acetonitrile are mixed and stirred for 5 h, and then 0.05 g of CuFe[Fe(CN)₆] is added. After stirring for 2 h, the mixed solution is obtained by ultrasonication at a frequency of 44 Hz for 30 min;

S2: after stirring the mixed solution at 60° C. for 12 h, the pretreated mixed solution is obtained. The pretreated mixed solution, injecting into a 10 mL plastic syringe with a stainless steel needle and connected with a high-voltage power supply. The applied voltage is maintained at 23 kV, and the flow rate of the syringe is set to 0.02 mL/h. A ground drum collector(400 r/min) is used to obtain a uniform membrane, and the distance from the tip to the drum is fixed at 16 cm. The composite solid electrolyte, recorded as PEO/1 % PBC-fiber, is obtained by taking out the spun membrane and drying it in a vacuum oven at 55° C. for 48 h.

### Example 7

S1: 5 g of PEO, 0.05 g of lithium bis(trifluoromethylsulfonyl)imide, and acetonitrile are mixed and stirred for 5 h, then 0.05 g of K_{0.95}Ag_{3.05}Fe(CN)₆ is added and stirred for 2 h. After that, the mixed solution is ultrasonicated at 44 Hz for 30 min to obtain a mixed solution;

S2: the mixed solution is stirred at 60° C. for 12 h to obtain a pretreated mixed solution. The pretreated mixed solution is placed into a 10 mL plastic syringe with a stainless steel needle and connecting to a high-voltage power supply. The applied voltage is maintained at 23 kV, and the flow rate of the syringe sets to 0.02 mL/h. A ground drum collector (400 r/min) is used to obtain a uniform membrane, and the distance from the tip to the drum is fixed at 16 cm. The electrospun membrane is taken out and dried in a vacuum oven at 55° C. for 48 h to obtain a composite solid electrolyte, recorded as PEO/1% PBK-fiber.

### Comparison Case 1

S1: 5 g of PEO, 0.05 g of lithium bis(trifluoromethylsulfonyl)imide, and acetonitrile are mixed and stirred for 5 h, after stirring for 2 h, the mixed solution is obtained by ultrasonication at a frequency of 44 Hz for 30 min;

S2: after stirring the mixed solution at 60° C. for 12 h, the pretreated mixed solution is obtained. The pretreated mixed solution is placed into a 10 mL plastic syringe with a stainless steel needle and connected to a high-voltage power supply. The applied voltage is maintained at 23 kV, and the flow rate of the syringe is set to 0.02 mL/h. A ground drum collector (400 r/min) is used to obtain a uniform membrane, and the distance from the tip to the drum is fixed at 16 cm. The spinning membrane is taken out and dried in a vacuum oven at 55° C. for 48 h to obtain a composite solid electrolyte, denoted as PEO-fiber.

### Comparison Case 2

The composite solid electrolyte is prepared by pouring, the composite solid electrolyte is recorded as PEO-cast membrane. The specific process comprises:

In a glove box filled with argon atmosphere, according to the standard of EO/Li molar ratio of 20:1, 1 g of PEO powder and 0.325 g of lithium bis (trifluoromethanesulfonyl)imide are mixed into 20 mL acetonitrile solution. After sealing, the mixture is continuously stirred for 12 h until the mixture is colorless and transparent. Subsequently, the solution pours into a mold made of polytetrafluoroethylene, drys at room temperature for 6 h, then transfers to a drying oven, and drys at 60° C. for 12 h. After the drying process is completed, the mold is taken out, and the product is cut into a round piece with a diameter of 16 mm, the round piece is stored in the glove box for subsequent experimental use.

### Characterization detection

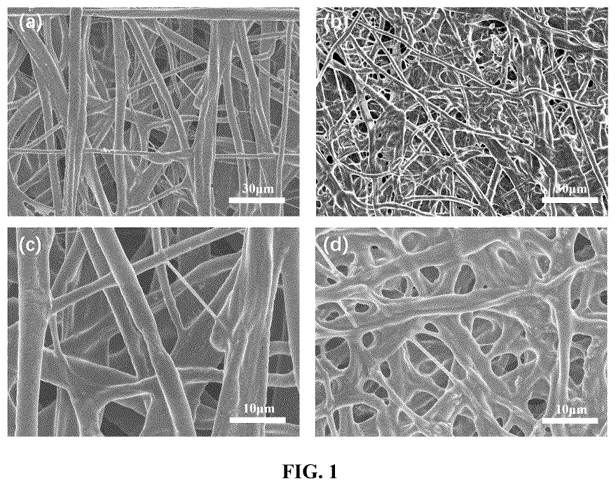

The composite solid electrolyte prepared by Example 3 and the composite solid electrolyte prepared by Comparison case 1 are observed by scanning electron microscopy, as shown in FIG. 1. It can be seen from FIG. 1(a) that the PEO-fiber (composite solid electrolyte prepared at Comparison case 1) is observed when the magnification is 1500 times. It can be find that the overall fiber shows a relatively smooth surface, and the fiber lines are straight. There are some pores between the fibers, but the distribution is not very regular, and the pores in some areas are large. FIG. 1(b) shows a SEM of PEO/1% PB-fiber (the composite solid electrolyte prepared in Example 3) after being enlarged by 1500 times, and it is find that it presents a different picture from PEO-fiber. The addition of PB (Fe₄[Fe(CN)₆]₃) makes the fiber surface in the composite system no longer smooth, and some granular or protuberant structures appear, and the line shape is an irregular curve. There are also pores between the fibers, but compared with the PEO-fiber, the overall pores are larger. The large pore distribution is conducive to the construction of more stable and more efficient ion conduction channels, which makes the ion conduction in the composite solid electrolyte smoother. As shown in FIG. 1(c) and FIG. 1(d), when the magnification is increased to 5000 times, the smooth and straight PEO-fiber can be seen more clearly. In contrast, a large number of particles appeared on the surface of PEO/1 % PB-fiber, indicating that PB is well dispersed in PEO fibers. And there are a large number of uniformly distributed pores in the interior, which are connected with the pores between the fibers. This is because the addition of PB makes the internal structure of the fiber change during the formation process, thus forming a more complex but orderly pore network.

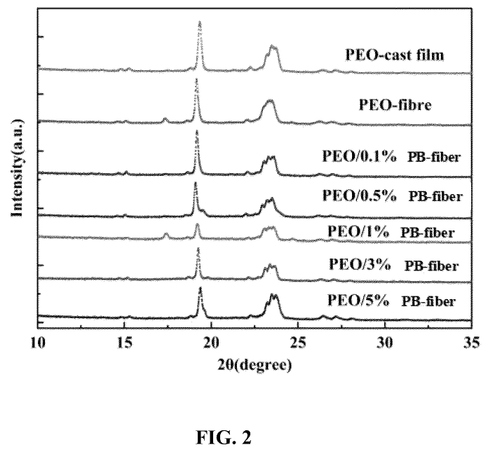

An XRD analysis is performed on the composite solid electrolytes prepares by Examples 1-5 and Comparison cases 1 and 2, as shown in FIG. 2. It can be seen from FIG. 2 that pure PEO has obvious sharp crystallization peaks at 2θ of 19.3° and 23.6° . These two characteristic peaks correspond to the (120) and (111) crystal planes of the PEO crystal phase, respectively. The crystallinity is calculated to be about 46 %, indicating that PEO is a highly ordered crystalline structure. When PB is gradually introduced into the system, the intensity of these crystallization peaks shows regular changes. Compared with the addition amount as a variable, when adding 0.1 % PB (Example 1), the crystallization peak intensity of PEO decreased slightly; when continuing to increase the PB to 1 %, the crystallization peak intensity decreases by about 60 %. Since the nano-scale rigid particles of PB are uniformly distributed in the PEO matrix, they hinder the orderly arrangement of the PEO molecular chains, making it difficult to form a complete crystalline region, and ultimately leading to a decrease in the degree of crystallization. The experimental data confirms that the addition of PB successfully inhibit the regular arrangement of PEO molecular chains and weaken their crystallization properties. When PB continues to be added, the crystallization peak intensity begins to decrease. This is because PB nanoparticles are prone to agglomeration. Aggregates form stress concentration points inside the material, changing the crystallization environment of PEO segments, making PEO molecular chains easier to arrange in an orderly manner near these aggregates, thereby promoting the crystallization process and leading to an increase in crystallinity.

### Performance test

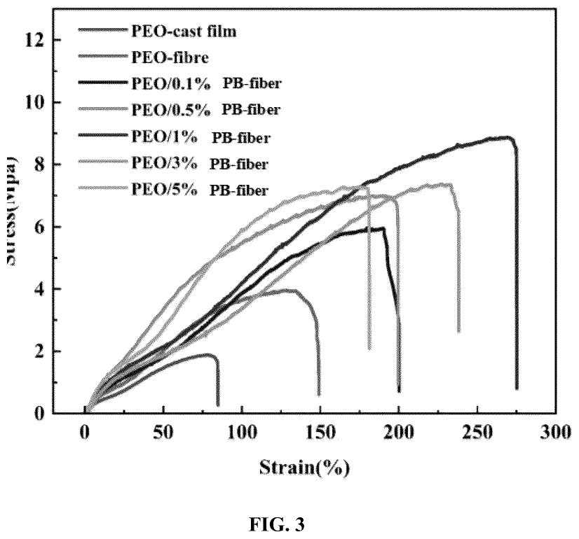

The tensile properties of the composite solid electrolytes prepared by Examples 1-5 and the Comparison cases 1 and 2 are tested, and the results are shown in FIG. 3.

From FIG. 3, it can be seen that the composite solid electrolyte prepared for the Comparison case 2 exhibits typical high flexibility but low strength characteristics during the stretching process. Its tensile strength is only 1.8 MPa, and the elongation at break is as high as 82 %. This means that the electrolyte is prone to fracture under a small external force. When PB is added to the system, the tensile strength and elongation at break changed significantly. As the amount of PB added gradually increases, the tensile strength gradually increases. When the addition amount of PB reached 1 %, the tensile strength increased to 8.9 MPa, which is about 400 % higher than that of Comparison case 2; the elongation at break increased to 275 %, at this time, the strength of the material is significantly enhanced while maintaining a certain flexibility. However, when PB continues to increase, the tensile strength decreases to 7.1 MPa, and the elongation at break decreases to 235 %. Although the flexibility of tensile strength decreases, it can still meet certain application requirements. This is because PB nanoparticles act as physical crosslinking points to form a ‘filler-polymer’ interface layer. When tensile, PB disperses the load through interfacial stress transfer and inhibits crack propagation. However, when the amount of PB added is too much, the particles are prone to agglomeration, and the aggregates form stress concentration points inside the material, which makes the material more likely to break from these weak parts when subjected to force, resulting in a decrease in flexibility.

### Thermal Performance Analysis

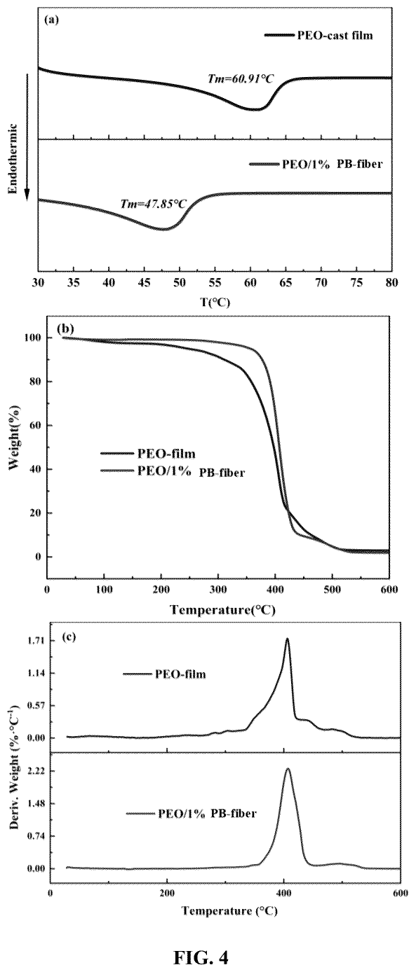

The thermal properties of the composite solid electrolyte prepared by Example 3 and Comparison case 2 are analyzed, and the results are shown in FIG. 4. From FIG. 4(a), the DSC test results show that the melting temperature (Tm) of the composite solid electrolyte prepared by the Comparison case 2 is about 60.91° C., 60.91° C. represents the transition temperature from the crystalline to the molten phase, reflecting the thermal stability of the PEO crystalline structure. When PB is added to the system, Tm changed significantly. Taking the addition of 1 % PB as an Example, Tm decreased to 47.85° C. This decrease in melting temperature and crystallization temperature means that the presence of PB interferes with the crystallization process of PEO segments. Specifically, the rigid structure of PB hinders the movement of PEO segments, making it difficult to quickly and orderly arrange to form crystallization during the cooling process, resulting in a decrease in crystallization temperature; at the same time, due to the decrease of crystallinity, the stability of the crystalline region becomes worse, and the melting temperature also decreases, in some embodiment confirms the conclusion that the crystallinity in an XRD decreases.

The TG curves of FIG. 4(b) and (c) show the weight change of the material during heating. Compared with the composite solid electrolyte prepared in Document 2, it began to lose weight obviously at about 350° C., which is due to the decomposition of polymer segments. After adding PB, the initial weight loss temperature increases significantly. The initial weight loss temperature is increased to 370° C., which indicates that the thermal stability of the composite electrolyte is enhanced. This is mainly because the rigid structure of PB and its interaction with PEO inhibit the thermal decomposition of the polymer to a certain extent, so that the material can maintain structural stability at higher temperatures.

### Application Example

The composite solid electrolyte prepared by Example 3 and Comparison case 2 is assembled into a lithium symmetrical battery, comprising: electrochemical performance characterization and testing by assembling a CR2032-type button cell composite solid electrolyte.

The assembly process comprises: completing the assembly of the button cell in the glove box (water and oxygen content are less than 0.01 ppm). Specifically, the high-purity lithium sheet is used as the positive electrode and the negative electrode (diameter of 15.6 mm, thickness of 0.4-0.5 mm), and the separator is a composite solid electrolyte prepared by Example 3 and Comparison case 2. The assembly is carried out in the order of high-purity lithium sheet, composite solid electrolyte (solid electrolyte membrane), high-purity lithium sheet, and then seal with a hydraulic sealing machine. The electrochemical performance is tested after standing in an oven at 45° C. for 12 h.

### Test of Ion Conductivity

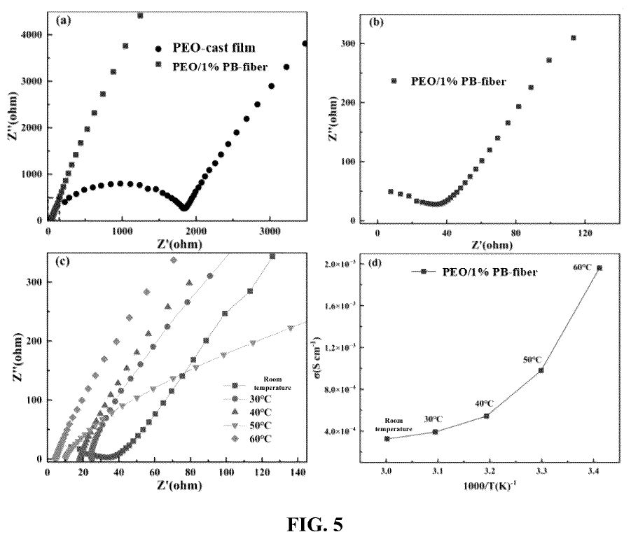

The lithium-ion battery prepared above is tested for ion conductivity, and the specific results are shown in FIG. 5.

It can be seen from FIG. 5(a) and FIG. 5(b) that the impedance of the composite solid electrolyte obtained by Example 3 is significantly smaller than that of Comparison case 2. At room temperature, the impedance of the composite solid electrolyte prepared at Comparison case 2 is about 2000 Ω, while the impedance of PEO/1 % PB-fiber is about 40 Ω, which is reduced by nearly 50 times. This is because under the action of the electric field, ions can move more efficiently through the nanopores of PB, reducing the obstacles in the transmission process, thereby reducing the impedance.

As shown in FIG. 5(d), with the increase of temperature, the ionic conductivity of the electrolyte shows an increasing trend, up to 1.96×10⁻³ S cm⁻¹, and the change trend of the conductivity of the composite electrolyte with temperature conforms to the Arrhenius equation. This phenomenon indicates that the introduction of PB improves the ion conductivity in many aspects. On the one hand, the three-dimensional nanochannels of PB provide a new path for ion transport and increase the number of ion transport channels; on the other hand, the coordination competition between PB and PEO or lithium bis (trifluoromethylsulfonyl)imide (LiTFSI) reduces the activation energy of ion transport, making it easier for ions to overcome energy barriers and migrate under the action of electric field, thus making ion conduction easier and significantly improving ionic conductivity.

### Charge and Discharge Cycle Test

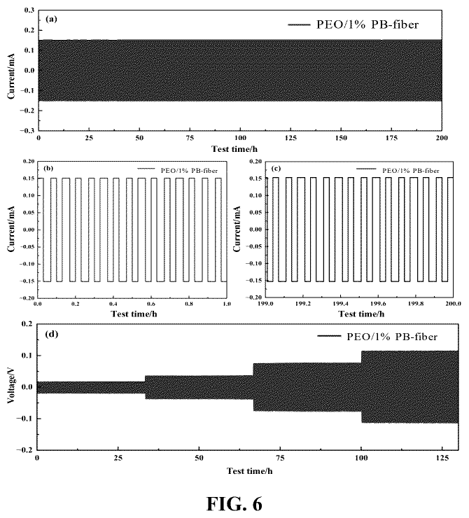

The battery assembled in the above implementation Example 3 is subjected to a long-term charge and discharge cycle test at a constant current density. The specific results are shown in FIG. 6. It can be seen from FIG. 6(a) and FIG. 6(b) that the overpotential is low and relatively stable at the beginning of the cycle. With the increase in the number of cycles, the overpotential is still stable and the fluctuation is small after 200 h of the cycle (FIG. 6(c)). This is due to the three-dimensional nanopore structure of PB and its interaction with PEO and LiTFSI. On the one hand, the nanochannels of PB contribute to the uniform transport of lithium ions and reduce the possibility of lithium dendrite growth; on the other hand, the coordination between PB and TFSI-inhibits the side reactions at the interface and keeps the interface resistance relatively stable. This indicates that there is good interface stability between the electrolyte and the lithium metal electrode during the charge and discharge process. FIG. 6(d) is the voltage polarization curve at different current densities. It can be seen that at low current densities, the overpotential remains stable and the interface stability is good. With the increase in the rate, the overpotential can still maintain a certain stability, and there are no serious problems such as short circuit, indicating that the addition of PB enhances the performance of the electrolyte at high rates to a certain extent.

### Cycle Performance Testing

The composite solid electrolyte prepared in Example 3 is assembled into a lithium iron phosphate/lithium sheet battery for a cycle performance test. The process comprises:

lithium iron phosphate, acetylene black, and polyvinylidene fluoride (PVDF) are accurately weighed at a mass ratio of 8:1:1. The above raw materials are transferred to the agate mortar, and an appropriate amount of N-methyl pyrrolidone is added as the dispersion medium. The viscosity of the mixed system is adjusted by continuous stirring, and a uniform positive electrode slurry is obtained by full grinding. The slurry is evenly distributed on the surface of the aluminum foil by the scraping process, and the thickness of the scraper is controlled at 100 μm. The coated sample is then heat-treated at 90° C. for 40 min. Finally, the cathode material is punched into a circular electrode sheet with a diameter of 14 mm using a slicing device and stored in an inert atmosphere glove box for subsequent use.

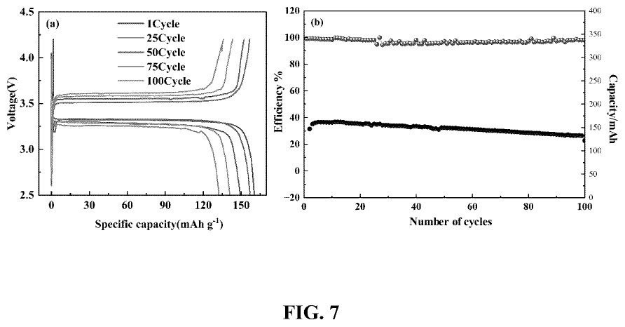

The assembly of the lithium-ion battery: the electrochemical performance of the solid electrolyte membrane is tested by assembling the CR2032 button battery. The button cell is assembled in the glove box (water and oxygen content is less than 0.01 ppm). The high-purity lithium sheet is used as the negative electrode (diameter 15.6 mm, thickness 0.4-0.5 mm), the counter electrode is the above-mentioned lithium iron phosphate electrode sheet, and the diaphragm is the composite solid electrolyte prepared by Example 3. According to the order of the lithium sheet, the composite solid electrolyte prepared by Example 3 and the lithium iron phosphate electrode sheet, the lithium sheet is assembled, and then sealed with a hydraulic sealing machine. After standing in an oven at 45° C. for 12 h, the cycle performance is tested, as shown in FIG. 7.

It can be seen from the charge-discharge cycle curve FIG. 7 (a) and the long cycle diagram FIG. 7 (b) that the composite solid electrolyte prepared by Example 3 performs well in charge-discharge performance and cycle stability. The Coulombic efficiency and capacity retention of the electrolyte are excellent under a long cycle at 0.1 C. The initial coulombic efficiency is close to 100 %, the average coulombic efficiency is 98.5 %, the initial discharge capacity is about 160 mAh g⁻¹, the capacity is about 130 mAh g⁻¹ after 100 cycles, and the capacity retention rate is 81.25 %. High coulombic efficiency and capacity retention rate mean that the energy loss of the battery during charge and discharge is small, and the reversibility of the electrode reaction is good. This indicates that the coordination between PB and TFSI⁻ inhibits the side reactions at the interface and reduces the loss of active substances, thereby improving the coulombic efficiency. The presence of PB enhances the structural stability of the electrolyte. During the long cycle, it can maintain good ion conductivity, provide a stable channel for the transmission of lithium ions, and help to maintain high coulombic efficiency.

### Cycle Rate Performance Test

The lithium iron phosphate/lithium sheet battery assembled in Example 3 is tested for cycle rate performance, and the results are shown in FIG. 8.

The performance at different charge and discharge rates is shown in FIG. 8(a) and FIG. 8(b). FIG. 8(a) shows that the first discharge specific capacity of the battery is 160 mAh g⁻¹ at 0.1 C rate. This indicates that the battery can achieve a higher discharge capacity at a lower rate. As the rate gradually increases to 2 C, the discharge specific capacity of the battery can still be maintained at 131 mAh g⁻¹.

It can be seen from the charge-discharge cycle curves at different rates that the lithium-ion battery has better rate performance and cycle stability after the composite solid electrolyte prepared by Example 3 is applied to the lithium-ion battery. Although the discharge specific capacity decreases with the increase of the rate, the capacity retention rate is relatively high. The composite solid electrolyte prepared by Example 3 can adapt to different charge and discharge rate requirements. This is due to the multi-level coordination regulation, pore-assisted transport, and kinetic optimization of PB, so that the composite solid electrolyte can effectively promote lithium ion transport at different rates, reduce polarization, and improve the overall performance of the battery.

Finally, it should be noted that the above examples are only used to explain the technical scheme of the present disclosure rather than to restrict it. Although the present disclosure is described in detail with reference to the better examples, ordinary technicians in this field should understand that they can still modify or replace the technical scheme of the present disclosure, and these modifications or equivalent replacements cannot make the modified technical scheme out of the spirit and scope of the technical scheme of the present disclosure.

What is claimed is:

1. A method of preparing a composite solid electrolyte, comprising the following steps:
S1, mixing Poly(ethylene oxide) (PEO), lithium bis(trifluoromethylsulfonyl)imide and acetonitrile, then adding Prussian blue analogues, stirring and ultrasonicating to obtain a mixed solution; and
S2, using electrospinning to make the mixed solution into a composite solid electrolyte.

2. The method of preparing a composite solid electrolyte according to claim 1, wherein a mass of lithium bis(trifluoromethanesulfonyl)imide in S1 is 0.5 %-1 % of the mass of PEO.

3. The method of preparing a composite solid electrolyte according to claim 1, wherein a mixing time in S1 is 4-6 h.

4. The method of preparing a composite solid electrolyte according to claim 1, wherein the Prussian blue analogues in S1 comprise Fe₄[Fe(CN)₆]₃, CuFe[Fe(CN)₆], or K_{0.95}Ag_{3.05}Fe(CN)₆.

5. The method of preparing a composite solid electrolyte according to claim 1, wherein the mass of the Prussian blue analogue in S1 accounts for 0.01 %-10 % of the mass of PEO.

6. The method of preparing a composite solid electrolyte according to claim 5, wherein the mass of the Prussian blue analogue in S1 accounts for 0.1 %-5 % of the mass of PEO.

7. The method of preparing a composite solid electrolyte according to claim 1, wherein the stirring time in S1 is 1-3 h, an ultrasonic time is 20-40 min, and an ultrasonic frequency is 42-45 Hz.

8. The method of preparing a composite solid electrolyte according to claim 1, wherein a voltage of electrospinning in S2 is 22-24 kV, and a flow rate of electrospinning is 0.015-0.025 mL/h.

9. The composite solid electrolyte prepared by the method of preparing a composite solid electrolyte according to claim 1.

10. The application of composite solid electrolyte in a lithium-ion battery according to claim 9.
